(19) United States
(12) Patent Application Publication
(10) Pub. No.: US 2026/0022744 A1
(43) Pub. Date: Jan. 22, 2026

(54) BRAKE DRIVE DEVICE FOR DRIVING MECHANICAL BRAKE DEVICE

(71) Applicant: FANUC CORPORATION, Minamitsuru-gun, Yamanashi (JP)

(72) Inventor: Keitarou INAGAKI, Minamitsuru-gun, Yamanashi (JP)

(73) Assignee: FANUC CORPORATION, Minamitsuru-gun, Yamanashi (JP)

(21) Appl. No.: 18/996,220

(22) PCT Filed: Oct. 25, 2022
(86) PCT No.: PCT/JP2022/039741

§ 371 Date: Jan. 17, 2025

(51) Int. Cl. F16D 59/02; F16D 65/18; F16D 121/14; F16D 121/22

(52) U.S. Cl. CPC F16D 59/02; F16D 65/18; F16D 2121/14; F16D 2121/22

(57) ABSTRACT

This brake drive device comprises: a switch that releases a brake by means of a mechanical brake device by performing an on-operation for causing a current to flow to the mechanical brake device, and actuates the brake by means of the mechanical brake device by performing an off-operation for causing a current not to flow to the mechanical brake device; and an energy storage circuit that is electrically connected to the mechanical brake device and stores energy. The energy for restricting a current change when the brake is released by means of the mechanical brake device is supplied to the mechanical brake device from the energy storage circuit.

### TECHNICAL FIELD

The present disclosure relates to a brake driving device that drives a mechanical brake device.

### BACKGROUND ART

In a motor driving device that drives a motor in a machine such as an industrial robot and a machine tool, a mechanical brake device is widely used for applying a brake to the rotating motor, and fixing the stopped motor in such a way as to prevent the motor from rotating. A switch is connected between a brake coil of the mechanical brake device and a power supply. A current flows from the power supply to the brake coil by the switch performing an ON motion, and the brake by the mechanical brake device is released. Further, a current is prevented from flowing from the power supply to the brake coil by the switch performing an OFF motion, and thus the brake of the mechanical brake device is actuated.

### CITATION LIST

### Patent Literature

[PTL 1] JP 2013-248946A

[PTL 2] JP 2011-195287A

[PTL 3] JP 2020-029877A

### SUMMARY OF INVENTION

### Technical Problem

While the mechanical brake device is in a brake releasing state, a test pulse for momentarily turning off the switch is periodically applied in order to monitor whether there is a fault in the switch between the brake coil and the power supply. When the test pulse is applied to the switch in the brake releasing state, a period in which no current flows through the brake coil is temporarily generated, and thus the brake may malfunction. Therefore, a brake driving device that can avoid a malfunction in the brake in the brake releasing state is desired.

### Solution to Problem

According to one aspect of the present disclosure, a brake driving device includes: a switch configured to release a brake by a mechanical brake device by performing an ON motion of causing a current to flow through the mechanical brake device, and actuate the brake by the mechanical brake device by performing an OFF motion of not causing a current to flow through the mechanical brake device; and an energy storage circuit that is electrically connected to the mechanical brake device and stores energy, wherein energy for suppressing a current change when the brake by the mechanical brake device is released is supplied from the energy storage circuit to the mechanical brake device.

### BRIEF DESCRIPTION OF DRAWINGS

FIG. 1 is a circuit diagram illustrating a brake driving device according to a first embodiment of the present disclosure.

FIG. 2 is a cross-sectional view illustrating a structure of a mechanical brake device controlled by the brake driving device according to the first embodiment and a second embodiment of the present disclosure, and illustrates a state where a brake is actuated for a motor.

FIG. 3 is a cross-sectional view illustrating a structure of the mechanical brake device controlled by the brake driving device according to the first and second embodiments of the present disclosure, and illustrates a state where the brake for the motor is released.

FIG. 4 is a circuit diagram illustrating the brake driving device according to the second embodiment of the present disclosure.

FIG. 5 is a timing chart illustrating each waveform in the brake driving device according to the first and second embodiments of the present disclosure.

FIG. 6 is a timing chart illustrating each waveform when the brake driving device according to the first and second embodiments of the present disclosure is actually caused to perform a motion.

FIG. 7 is a timing chart illustrating each waveform when a brake driving device according to a conventional example without an energy storage circuit is actually caused to perform a motion.

### DESCRIPTION OF EMBODIMENTS

Hereinafter, a brake driving device that drives a mechanical brake device according to embodiments will be described with reference to drawings. It should be noted that a configuration having the same or similar function is provided with the same reference sign in the following description. Then, a redundant description of the configuration may be omitted. Herein, “ON” of a switch means closing of an electric circuit provided with the switch, that is, when a switch performs an ON motion, an electric circuit provided with the switch is connected and brought into a closed state. Further, “OFF” of a switch means opening of an electric circuit provided with the switch, that is, when a switch performs an OFF motion, an electric circuit provided with the switch is disconnected and brought into an open state.

### Configuration of Brake Driving Device According to First Embodiment

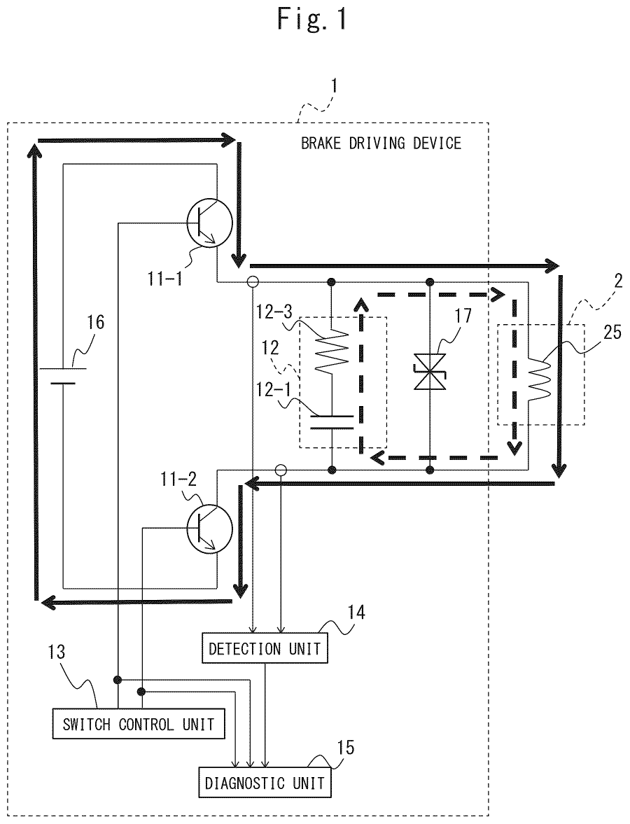

FIG. 1 is a circuit diagram illustrating a brake driving device according to a first embodiment of the present disclosure.

A mechanical brake device 2 controlled by a brake driving device 1 according to the first embodiment of the present disclosure is a brake device of a non-excitation actuating type that actuates a brake during non-excitation without application of a voltage to a brake coil 25, and releases the brake during excitation with application of a voltage to the brake coil 25.

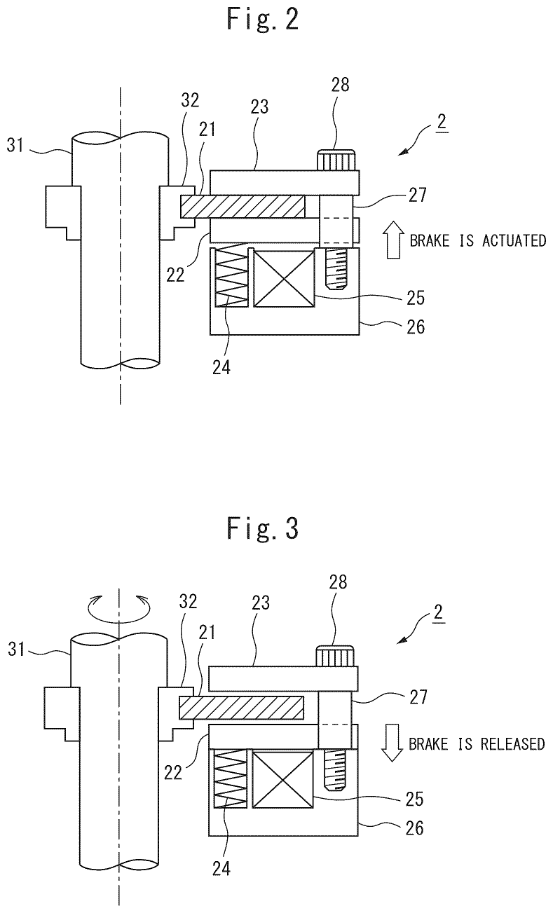

Prior to the description of the brake driving device 1 according to the first embodiment of the present disclosure, a structure of the mechanical brake device 2 will be described with reference to FIGS. 2 and 3. FIG. 2 is a cross-sectional view illustrating a structure of the mechanical brake device controlled by the brake driving device according to the first embodiment and a second embodiment of the present disclosure, and illustrates a state where a brake is actuated for a motor. FIG. 3 is a cross-sectional view illustrating a structure of the mechanical brake device controlled by the brake driving device according to the first and second embodiments of the present disclosure, and illustrates a state where the brake for the motor is released. The mechanical brake device 2 illustrated in FIGS. 2 and 3 is applicable to the first and second embodiments.

As illustrated in FIGS. 2 and 3, in the mechanical brake device 2, a friction plate 21 is disposed between an armature 22 and an end plate 23. A hub 32 is spline-coupled to the friction plate 21. The hub 32 and a shaft 31 of a motor are integrated by, for example, shrink fitting, and thus the friction plate 21 also rotates in conjunction with rotation of the shaft 31 of the motor. The end plate 23 and a spacer 27 are coupled by a bolt 28, and the armature 22 is coupled to the spacer 27 in such a way that the armature 22 can move in a direction closer to and a direction away from the friction plate 21. A spring 24 and the brake coil 25 are provided in a core 26. As illustrated in FIG. 2, in a non-excitation state where no voltage is applied to the brake coil 25, the armature 22 is strongly pressed against the friction plate 21 by an elastic force of the spring 24, and the friction plate 21 is sandwiched between the armature 22 and the end plate 23 and cannot rotate. As a result, the shaft 31 of the motor coupled to the friction plate 21 cannot also rotate, which results in a state where the brake is actuated for the motor (brake actuating state). On the other hand, as illustrated in FIG. 3, in an excitation state where a brake current flows through the brake coil 25, an electromagnetic force that defeats an elastic force of the spring 24 for pressing the armature 22 against the friction plate 21 is generated in the core 26, and the armature 22 is thus brought closer to the core 26, and the friction plate 21 is released from contact with the armature 22 and the end plate 23. As a result, the friction plate 21 and thus the shaft 31 of the motor can freely rotate, which results in a state where the brake for the motor is released (brake releasing state).

In such a manner, the hub 32 of the mechanical brake device 2 and the shaft 31 of the motor are fixed. The motor to which the mechanical brake device 2 is attached may be an alternating-current motor or may be a direct-current motor. Machines provided with a motor include, for example, an industrial robot, a machine tool, and the like.

The mechanical brake device 2 is controlled by the brake driving device 1. As illustrated in FIG. 1, the brake driving device 1 according to the first embodiment of the present disclosure includes switches 11-1 and 11-2, an energy storage circuit 12, a switch control unit 13, a detection unit 14, a diagnostic unit 15, a power supply 16, and a surge absorber 17. FIG. 1 illustrates only the brake coil 25 for the mechanical brake device 2.

The power supply 16 outputs a direct-current voltage. The power supply 16 is formed of, for example, a rectifier that converts an alternating current voltage into a direct-current voltage, a switching regulator, a battery, or the like. As one example, the power supply 16 outputs a direct-current voltage having a voltage value of 24 V, but may be a power supply that outputs a direct-current voltage having another voltage value (for example, 15 V, 12 V, 5 V, and the like).

The switches 11-1 and 11-2 are each connected in series with the brake coil 25 of the mechanical brake device 2. In the example illustrated in FIG. 1, the switch 11-1 (hereinafter may be referred to as an “upper switch”) that opens and closes an electric circuit between a positive terminal of the power supply 16 and a positive terminal of the brake coil 25, and the switch 11-2 (hereinafter may be referred to as a “lower switch”) that opens and closes an electric circuit between a negative terminal of the power supply 16 and a negative terminal of the brake coil 25 are provided. It should be noted that, in the example illustrated in FIG. 1, one upper switch and one lower switch are provided, but two or more upper switches and two or more lower switches may be provided as a modification example. As an example of the switches 11-1 and 11-2, there are an FET, an IGBT, a thyristor, a GTO, a transistor, a relay, and the like. A kind itself of the switches 11-1 and 11-2 does not limit the present embodiment, and a switching element other than the exemplified switch may be used.

When the switches 11-1 and 11-2 receive an ON signal from the switch control unit 13, the switches 11-1 and 11-2 perform the ON motion and close the electric circuit between the power supply 16 and the brake coil 25. In this way, a current flows from the power supply 16 to the brake coil 25, and thus a brake by the mechanical brake device 2 is released (brake releasing state). When the switches 11-1 and 11-2 receive an OFF signal from the switch control unit 13, the switches 11-1 and 11-2 perform the OFF motion and open the electric circuit between the power supply 16 and the brake coil 25. In this way, a current from the power supply 16 to the brake coil 25 is cut off, and thus the brake by the mechanical brake device 2 is actuated (brake actuating state). It should be noted that, while the mechanical brake device 2 is in the brake releasing state, the switch control unit 13 periodically applies, to the switches 11-1 and 11-2, a test pulse momentarily with the OFF signal during an output of the ON signal in order to monitor whether there is a fault in the switches 11-1 and 11-2. When there is no fault in the switches 11-1 and 11-2, the switches 11-1 and 11-2 perform the OFF motion for a short period of time in response to the test pulse.

The surge absorber 17 is connected between the positive terminal and the negative terminal of the brake coil 25 in such a way as to be connected in parallel with the mechanical brake device 2. The surge absorber 17 removes a momentary high voltage such as an opening/closing surge and noise of the switches 11-1 and 11-2.

The energy storage circuit 12 is electrically connected to the mechanical brake device 2, and stores energy. In the first embodiment of the present disclosure, the energy storage circuit 12 includes a capacitor 12-1 connected in parallel with the brake coil 25 of the mechanical brake device 2. It should be noted that, when the switches 11-1 and 11-2 perform the ON motion, the capacitor 12-1 is charged in a short period of time. A large current flows from the power supply 16 during charging of the capacitor 12-1, and thus there is a possibility that the switches 11-1 and 11-2 may be damaged. Thus, a current restricting resistor 12-3 is preferably connected in series with the capacitor 12-1 in order to suppress such a large current. It should be noted that a capacity C of the capacitor 12-1 needs to be set to magnitude in which a malfunction in the brake due to the test pulse does not occur in the brake releasing state, and the magnitude of the capacity C may be determined by, for example, reproducing the brake driving device 1 by a simulation and actually causing the brake driving device 1 to perform a motion.

While the mechanical brake device 2 is in the brake releasing state, the test pulse is periodically applied to the switches 11-1 and 11-2, and a current flowing through the brake coil 25 thus temporarily decreases. The capacitor 12-1 in the energy storage circuit 12 supplies, to the brake coil 25 of the mechanical brake device 2, energy (charge) that suppresses a current change when the brake by the mechanical brake device 2 is released. In the brake releasing state, even when the test pulse is applied to the switches 11-1 and 11-2 and a current supplied from the power supply 16 to the brake coil 25 decreases, a current is supplied to the brake coil 25, based on energy (charge) stored in the capacitor 12-1 in the energy storage circuit 12, and thus a current change in the brake coil 25 can be suppressed.

The switch control unit 13 outputs the ON signal for causing the switches 11-1 and 11-2 to perform the ON motion, and the OFF signal for causing the switches 11-1 and 11-2 to perform the OFF motion. Further, the switch control unit 13 performs control in such a way as to cause the switch 11-1 or 11-2 to perform the OFF motion for a fixed period of time while the mechanical brake device 2 is in the brake releasing state by causing the switches 11-1 and 11-2 to perform the ON motion. In other words, in the brake releasing state, the switch control unit 13 outputs, alternately to the switches 11-1 and 11-2, the test pulse momentarily and periodically with the OFF signal during an output of the ON signal.

The detection unit 14 detects a potential of a power line connecting between the switches 11-1 and 11-2 and the mechanical brake device 2 when the switches 11-1 and 11-2 are caused to perform the ON motion by control of the switch control unit 13, and the switch control unit 13 outputs the test pulse while the mechanical brake device 2 is in the brake releasing state. A detection result of the potential by the detection unit 14 is transmitted to the diagnostic unit 15.

The diagnostic unit 15 makes a diagnosis of presence or absence of a fault in the switches 11-1 and 11-2, based on the detection result of the potential by the detection unit 14.

A diagnostic result by the diagnostic unit 15 may be displayed on, for example, a display device (not illustrated). As an example of the display device, there are a single display device, a display device attached to the brake driving device 1 or a motor driving device including the brake driving device 1, a display device attached to a personal computer and a portable terminal, and the like. For example, the display device performs display of, for example, “switch is normal” or “switch is faulty”. The above-described display example by the display device is merely one example, and “switch is normal” and “switch is faulty” may be displayed based on the other expression and illustration.

A diagnostic result by the diagnostic unit 15 may be output from an acoustic device (not illustrated) that outputs a sound such as, for example, a voice, a speaker, a buzzer, and a chime. For example, in order to be able to distinguish a difference between “switch is normal” and “switch is faulty”, a tone color, a musical scale, a rhythm, a melody, or the like may be set. Further, the acoustic device may be silent when “switch is normal”, and may output a sound only when “switch is faulty”.

A diagnostic result by the diagnostic unit 15 may be printed out on paper and the like by using a printer and may be displayed.

The examples of notification about a diagnostic result by the diagnostic unit 15 to an operator are described above, and may be combined as appropriate and achieved. Further, every time a diagnostic result by the diagnostic unit 15 is acquired, the diagnostic result may be stored, accumulated, databased, and thus used to aid in fault prediction and preventive maintenance.

An operator can quickly and reliably recognize a state of the switches 11-1 and 11-2 of the brake driving device 1, based on a notified diagnostic result by the diagnostic unit 15. Thus, when the operator can confirm that the switch 11-1 or 11-2 is faulty from the diagnostic result by the diagnostic unit 15, for example, the operator can take action such as exchange or repair of the switch 11-1 or 11-2.

At least one processor being an arithmetic processing device is provided in the brake driving device 1 or the motor driving device including the brake driving device 1. As the arithmetic processing device, for example, there are an IC, an LSI, a CPU, an MPU, a DSP, and the like. The arithmetic processing device includes the switch control unit 13, the detection unit 14, the diagnostic unit 15, and the other processing circuit. Each of these units included in the arithmetic processing device is, for example, a functional module achieved by a program executed on a processor. For example, when the switch control unit 13, the detection unit 14, the diagnostic unit 15, and the other processing circuit are constituted in a program form, the arithmetic processing device performs a motion according to the program, and thus a function of each unit can be achieved. The program for executing each piece of processing of the switch control unit 13, the detection unit 14, the diagnostic unit 15, and the other processing circuit may be provided in form of being recorded in a computer-readable recording medium, such as a semiconductor memory, a magnetic recording medium, or an optical recording medium. Alternatively, the switch control unit 13, the detection unit 14, the diagnostic unit 15, and the other processing circuit may be achieved as a semiconductor integrated circuit to which the program that achieves the function of each unit is written.

At least one memory being a storage device is provided in the brake driving device 1 or the motor driving device including the brake driving device 1. As the memory, there are a non-volatile memory being electrically erasable and recordable such as, for example, an EEPROM (registered trademark), a random access memory that can perform reading and writing at a high speed such as, for example, a DRAM and an SRAM, or the like. Further, the storage device may have a configuration such as, for example, an HDD and an SSD. The program for causing the switch control unit 13, the detection unit 14, the diagnostic unit 15, and the other processing circuit to perform a motion may be stored in the memory. A potential detection result acquired by the detection unit 14 is stored in the memory. A diagnostic result by the diagnostic unit 15 is stored in the memory. Various data related to the brake driving device 1 or the motor driving device including the brake driving device 1 are stored in the memory.

### Configuration of Brake Driving Device According to Second Embodiment

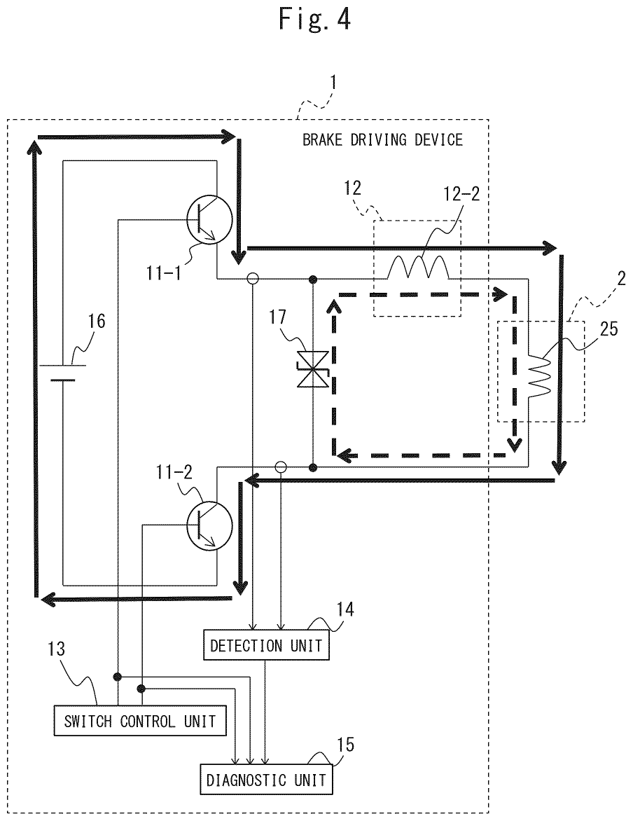

FIG. 4 is a circuit diagram illustrating the brake driving device according to the second embodiment of the present disclosure.

The second embodiment of the present disclosure includes an energy storage circuit 12 including an inductor 12-2 instead of the energy storage circuit 12 including the capacitor 12-1 in the first embodiment described above.

Similarly to the first embodiment described above, a brake driving device 1 according to the second embodiment of the present disclosure also controls a mechanical brake device 2. The mechanical brake device 2 is as described with reference to FIGS. 2 and 3.

As illustrated in FIG. 4, the brake driving device 1 according to the second embodiment of the present disclosure includes switches 11-1 and 11-2, the energy storage circuit 12, a switch control unit 13, a detection unit 14, a diagnostic unit 15, a power supply 16, and a surge absorber 17. FIG. 4 illustrates only a brake coil 25 for the mechanical brake device 2.

The switches 11-1 and 11-2, the switch control unit 13, the detection unit 14, the diagnostic unit 15, the power supply 16, and the surge absorber 17 are as described with reference to FIG. 1 in the first embodiment.

The energy storage circuit 12 is electrically connected to the mechanical brake device 2, and stores energy. In the second embodiment of the present disclosure, the energy storage circuit 12 includes the inductor (coil) 12-2 connected in series with the brake coil 25 of the mechanical brake device 2. It should be noted that an inductance L of the inductor 12-2 needs to be set to magnitude in which a malfunction in a brake due to a test pulse does not occur in a brake releasing state, and the magnitude of the inductance L may be determined by, for example, reproducing the brake driving device 1 by a simulation and actually causing the brake driving device 1 to perform a motion.

While the mechanical brake device 2 is in the brake releasing state, the test pulse is periodically applied to the switches 11-1 and 11-2, and a current flowing through the brake coil 25 thus temporarily decreases. The inductor 12-2 in the energy storage circuit 12 supplies, to the brake coil 25 of the mechanical brake device 2, energy that suppresses a current change when a brake by the mechanical brake device 2 is released. In the brake releasing state, even when the test pulse is applied to the switches 11-1 and 11-2 and a current supplied from the power supply 16 to the brake coil 25 decreases, a current is supplied to the brake coil 25, based on magnetic energy stored in the inductor 12-2 in the energy storage circuit 12, and thus a current change in the brake coil 25 can be suppressed.

It should be noted that the first embodiment and the second embodiment of the present disclosure may be executed in combination, and, in this case, the energy storage circuit 12 includes the capacitor 12-1 connected in parallel with the brake coil 25 of the mechanical brake device 2 and the inductor 12-2 connected in series with the brake coil 25 of the mechanical brake device 2.

### Motion of Brake Driving Device According to First and Second Embodiments

FIG. 5 is a timing chart illustrating each waveform in the brake driving device according to the first and second embodiments of the present disclosure.

Herein, the switch 11-1 that opens and closes the electric circuit between the positive terminal of the power supply 16 and the positive terminal of the brake coil 25 is referred to as an “upper switch”, and the switch 11-2 that opens and closes the electric circuit between the negative terminal of the power supply 16 and the negative terminal of the brake coil 25 is referred to as a “lower switch”. Further, a potential of the power line connecting between the upper switch (switch 11-1) and the positive terminal of the brake coil 25, which is detected by the detection unit 14, is referred to as an “upper detection signal”. Further, a potential of the power line connecting between the lower switch (switch 11-2) and the positive terminal of the brake coil 25, which is detected by the detection unit 14, is referred to as a “lower detection signal”. FIG. 5 illustrates, in order from the top with a lapse of time, a switch signal of ON and OFF being applied to the upper switch by the switch control unit 13, a switch signal of ON and OFF being applied to the lower switch by the switch control unit 13, an upper detection signal being detected by the detection unit 14, a lower detection signal being detected by the detection unit 14, and a current flowing through the brake coil 25 of the mechanical brake device 2.

In FIG. 5, in an initial state from a time 0 to a time t₁, the OFF signal is output from the switch control unit 13 to the upper switch and the lower switch, and, therefore, the upper switch and the lower switch perform the OFF motion and open the electric circuit between the power supply 16 and the brake coil 25. While the upper switch and the lower switch perform the OFF motion, a current from the power supply 16 to the brake coil 25 is cut off, and thus the brake by the mechanical brake device 2 is actuated (brake actuating state).

At the time t₁, the ON signal is output from the switch control unit 13 to the upper switch and the lower switch, and thus the upper switch and the lower switch perform the ON motion and close the electric circuit between the power supply 16 and the brake coil 25. While the upper switch and the lower switch perform the ON motion, a current flows from the power supply 16 to the brake coil 25, and thus the brake by the mechanical brake device 2 is released (brake releasing state).

At and after the time t₁, the mechanical brake device 2 is in the brake releasing state.

During that time, the switch control unit 13 applies, periodically and alternately to the switches 11-1 and 11-2, the test pulse momentarily with the OFF signal during an output of the ON signal. For example, at times t₃, t₅, and t₇, the switch control unit 13 applies, to the upper switch, a test pulse momentarily and periodically with an OFF signal TP1 during an output of the ON signal. For example, at times t₂, t₄, and t₆, the switch control unit 13 applies, to the lower switch, a test pulse momentarily and periodically with an OFF signal TP2 during an output of the ON signal.

With the mechanical brake device 2 in the brake releasing state at and after the time t₁, when the upper switch is normal, the upper switch performs the OFF motion in response to the periodically applied OFF signal TP1 while the upper switch performs the ON motion in response to the ON signal. As a result, a potential of the power line connecting between the upper switch and the positive terminal of the brake coil 25 changes at a point at the times t₃, t₅, and t₇ at which the OFF signal TP1 is applied to the upper switch. The detection unit 14 detects this as the upper detection signal. When the upper switch is normal, the upper detection signal corresponding to the test pulse applied to the upper switch is output from the detection unit 14. Thus, when the upper detection signal corresponding to the test pulse applied to the upper switch is output, the diagnostic unit 15 determines that the upper switch is normal. On the other hand, when the upper switch is faulty, the upper switch does not normally perform a motion, and thus the upper detection signal corresponding to the test pulse applied to the upper switch is not output. Thus, when the upper detection signal corresponding to the test pulse applied to the upper switch is not output, the diagnostic unit 15 determines that the upper switch is faulty.

Similarly, with the mechanical brake device 2 in the brake releasing state at and after the time t₁, when the lower switch is normal, the lower switch performs the OFF motion in response to the periodically applied OFF signal TP2 while the lower switch performs the ON motion in response to the ON signal. As a result, a potential of the power line connecting between the lower switch and the negative terminal of the brake coil 25 changes at a point at the times t₂, t₄, and t₆ at which the OFF signal TP2 is applied to the lower switch. The detection unit 14 detects this as the lower detection signal. When the lower switch is normal, the lower detection signal corresponding to the test pulse applied to the lower switch is output from the detection unit 14. Thus, when the lower detection signal corresponding to the test pulse applied to the lower switch is output, the diagnostic unit 15 determines that the lower switch is normal. On the other hand, when the lower switch is faulty, the lower switch does not normally perform a motion, and thus the lower detection signal corresponding to the test pulse applied to the lower switch is not output. Thus, when the lower detection signal corresponding to the test pulse applied to the lower switch is not output, the diagnostic unit 15 determines that the lower switch is faulty.

In such a manner, when the mechanical brake device 2 is in the brake releasing state, the switch control unit 13 applies, periodically and alternately to the switches 11-1 and 11-2, the test pulse momentarily with the OFF signal during an output of the ON signal. When the switches 11-1 and 11-2 are normal, the upper switch and the lower switch each momentarily perform the OFF motion at a point at the times t₂, t₃, t₄, t₅, t₆, and t₇ at which the OFF signal TP1 to the upper switch and the OFF signal TP2 to the lower switch are output from the switch control unit 13. As a result, a current flowing through the brake coil 25 decreases. When a degree of a current change (current decrease) in the brake coil 25 is great, a current flowing through the brake coil 25 decreases, and an electromagnetic force generated in the core 26 is weakened. When an clastic force of the spring 24 defeats an electromagnetic force generated in the core 26, the armature 22 is strongly pressed against the friction plate 21, the shaft 31 of the motor coupled to the friction plate 21 cannot rotate, and a brake for the motor malfunctions. The mechanical brake device 2 having smaller size and lighter weight reduces energy accumulated in the brake coil 25, and thus a malfunction in the brake of the mechanical brake device 2 due to the test pulse is more likely to occur. Thus, in the brake driving device 1 according to the first and second embodiments of the present disclosure, a current that compensates for a decrease in a current of the brake coil 25 is supplied based on energy stored in the energy storage circuit 12. In other words, in the brake releasing state, even when the test pulse is applied to the switches 11-1 and 11-2 and a current supplied from the power supply 16 to the brake coil 25 decreases, a current is supplied to the brake coil 25 by energy (charge) accumulated in the energy storage circuit 12, and thus a current change in the brake coil 25 can be suppressed. In this way, a malfunction in the brake due to a decrease in a current flowing through the brake coil 25 in the brake releasing state can be avoided.

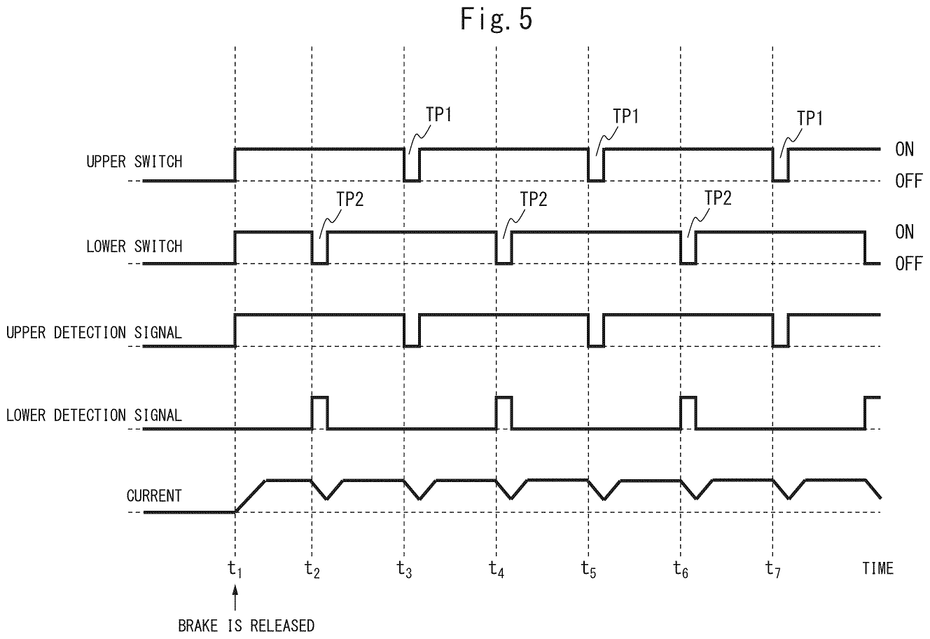

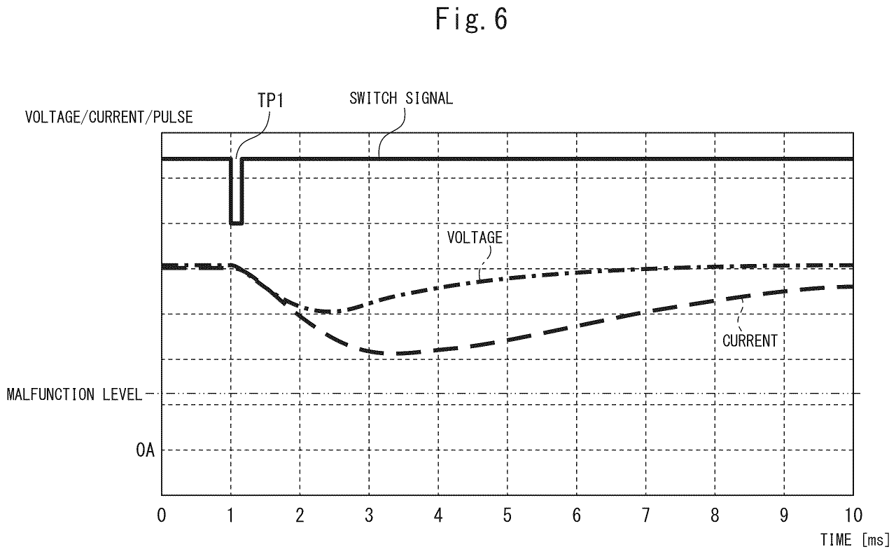

FIG. 6 is a timing chart illustrating each waveform when the brake driving device according to the first and second embodiments of the present disclosure is actually caused to perform a motion. FIG. 6 illustrates, by a solid line, a switch signal of ON and OFF being applied to the upper switch by the switch control unit 13, illustrates, by a dot-and-dash line, a voltage applied to the brake coil 25 of the mechanical brake device 2, and illustrates, by a broken line, a current flowing through the brake coil 25 of the mechanical brake device 2.

As illustrated in FIG. 6, when the mechanical brake device 2 is in the brake releasing state, the switch control unit 13 applies, to the upper switch, the test pulse momentarily and periodically with the OFF signal TP1 during an output of the ON signal at a point in time after 1 millisecond since start. In this way, the voltage applied to the brake coil 25 temporarily decreases, and the current flowing through the brake coil 25 of the mechanical brake device 2 also accordingly temporarily decreases. However, energy stored in the energy storage circuit 12 is supplied to the brake coil 25, and thus a decrease in the voltage applied to the brake coil 25 slows down and then the voltage starts rising. Accordingly, the current flowing through the brake coil 25 also slowly decreases and then starts rising, and thus the current flowing through the brake coil 25 does not decrease to equal to or lower than a malfunction level. Thus, a malfunction in the brake in the brake releasing state can be avoided.

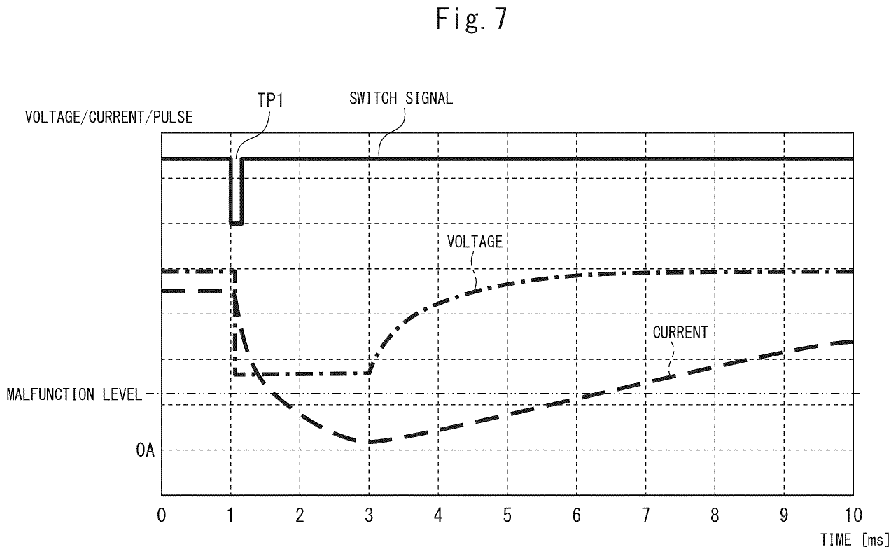

FIG. 7 is a timing chart illustrating each waveform when a brake driving device according to a conventional example without an energy storage circuit is actually caused to perform a motion. FIG. 7 illustrates, by a solid line, a switch signal of ON and OFF being applied to the upper switch by the switch control unit 13, illustrates, by a dot-and-dash line, a voltage applied to the brake coil 25 of the mechanical brake device 2, and illustrates, by a broken line, a current flowing through the brake coil 25 of the mechanical brake device 2.

As illustrated in FIG. 7, when the mechanical brake device 2 is in the brake releasing state, the switch control unit 13 applies, to the upper switch, the test pulse momentarily and periodically with the OFF signal TP1 during an output of the ON signal at a point in time after 1 millisecond since start. In this way, the voltage applied to the brake coil 25 decreases, and the current flowing through the brake coil 25 also accordingly decreases. The voltage applied to the brake coil 25 continues to be in a state of decreasing until a point in time after 3 milliseconds since start, and then finally starts rising. The state where the voltage applied to the brake coil 25 decreases continues for about 2 milliseconds, and thus the current flowing through the brake coil 25 greatly decreases. The current flowing through the brake coil 25 falls below the malfunction level at a point in time after about 1.7 milliseconds since the start, and further decreases to the vicinity of 0 A (zero ampere) at a point in time after 3 milliseconds since the start. The reason is that the energy storage circuit is not provided in the brake driving device in the conventional example. The current flowing through the brake coil 25 falls below the malfunction level, and thus a malfunction in the brake of the mechanical brake device 2 due to the test pulse during the brake releasing state occurs in the brake driving device in the conventional example.

As seen from the comparison between FIGS. 6 and 7, according to the first and second embodiments of the present disclosure, by providing the energy storage circuit 12 in the brake driving device 1, a current change (current decrease) in the brake coil 25 when the brake by the mechanical brake device 2 is released can be effectively suppressed. Thus, according to the first and second embodiments of the present disclosure, a malfunction in the brake in the brake releasing state can be avoided.

The mechanical brake device 2 having smaller size and lighter weight reduces energy accumulated in the brake coil 25, and thus an effect of suppressing a current change (current decrease) in the brake coil 25 by the energy storage circuit 12 is further enhanced.

For example, in a machine tool, a workpiece may be processed by smoothly rotating a motor to which a tool is attached. A brake is released during rotation of the motor, and, during that time, a fault diagnosis of a switch using a test pulse is performed in a brake driving device. When the brake temporarily malfunctions due to the test pulse even in the brake releasing state, a rotational speed of the motor may decrease and processing accuracy may be affected. Further, a malfunction in the brake wears a friction plate of the mechanical brake device more than necessary. According to the first and second embodiments of the present disclosure, a malfunction in the brake in the brake releasing state can be avoided, and thus wear of the friction plate can also be suppressed without lowering processing accuracy of a machine tool.

Although the present disclosure has been described above in detail, the present disclosure is not limited to the individual embodiments described above. Various types of addition, replacement, modification, partial deletion, and the like may be made to the embodiments without departing from the purpose of the present disclosure or without departing from the contents described in the claims and the scope of the present disclosure derived from equivalents thereof. Further, the embodiments can be performed in combination. For example, in the embodiments described above, an order of operations and an order of pieces of processing are indicated as one example, which is not limited thereto. Further, the same also applies to a case where a numerical value or a numerical expression is used in the description of the embodiments described above.

### Supplementary Note

With regard to the embodiments and the modification examples described above, supplementary notes below are further disclosed.

### Supplementary Note 1

A brake driving device 1 including:
a switch 11-1, 11-2 configured to release a brake by a mechanical brake device 2 by performing an ON motion of causing a current to flow through the mechanical brake device 2, and actuate the brake by the mechanical brake device 2 by performing an OFF motion of not causing a current to flow through the mechanical brake device 2; and
an energy storage circuit 12 that is electrically connected to the mechanical brake device 2 and stores energy, wherein
energy for suppressing a current change when the brake by the mechanical brake device 2 is released is supplied from the energy storage circuit 12 to the mechanical brake device 2.

### Supplementary Note 2

The brake driving device 1 according to supplementary note 1, further including
a switch control unit 13 configured to perform control in such a way as to cause the switch 11-1, 11-2 to perform the OFF motion for a fixed period of time while the brake by the mechanical brake device 2 is released by causing the switch 11-1, 11-2 to perform the ON motion.

### Supplementary Note 3

The brake driving device according to supplementary note 2, further including:
a detection unit 14 configured to detect a potential of a power line connecting between the switch 11-1, 11-2 and the mechanical brake device 2 when the switch 11-1, 11-2 is caused to perform the OFF motion for a fixed period of time while the brake by the mechanical brake device 2 is released by causing the switch 11-1, 11-2 to perform the ON motion by control of the switch control unit 13; and
a diagnostic unit 15 configured to make a diagnosis of presence or absence of a fault in the switch 11-1, 11-2, based on a detection result of a potential by the detection unit 14.

### Supplementary Note 4

The brake driving device 1 according to any one of supplementary notes 1 to 3, wherein
the energy storage circuit 12 includes a capacitor 12-1 connected in parallel with a brake coil 25 of the mechanical brake device 2.

### Supplementary Note 5

The brake driving device 1 according to any one of supplementary notes 1 to 4, wherein
the energy storage circuit 12 includes an inductor 12-2 connected in series with the brake coil 25 of the mechanical brake device 2.

### Supplementary Note 6

The brake driving device 1 according to any one of supplementary notes 1 to 5, wherein
the mechanical brake device 2 applies a brake to a motor by pressing, by an elastic force of a spring 24, an armature 22 against a friction plate 21 to which a shaft 31 of the motor is coupled, and releases the brake to the motor by separating the armature 22 from the friction plate 21 by an electromagnetic force generated by a current flowing through the brake coil 25.

### REFERENCE SIGNS LIST

1 Brake driving device
2 Mechanical brake device
11-1, 11-2 Switch
12 Energy storage circuit
12-1 Capacitor
12-2 Inductor
12-3 Current restricting resistor
13 Switch control unit
14 Detection unit
15 Diagnostic unit
16 Power supply
17 Surge absorber
21 Friction plate
22 Armature
23 End plate
24 Spring
25 Brake coil
26 Corc
27 Spacer
28 Bolt
31 Shaft
32 Hub

1. A brake driving device comprising:
a switch configured to release a brake by a mechanical brake device by performing an ON motion of causing a current to flow through the mechanical brake device, and actuate the brake by the mechanical brake device by performing an OFF motion of not causing a current to flow through the mechanical brake device; and
an energy storage circuit that is electrically connected to the mechanical brake device and stores energy, wherein
energy for suppressing a current change when the brake by the mechanical brake device is released is supplied from the energy storage circuit to the mechanical brake device.

2. The brake driving device according to claim 1, further comprising
a switch control unit configured to perform control in such a way as to cause the switch to perform the OFF motion for a fixed period of time while the brake by the mechanical brake device is released by causing the switch to perform the ON motion.

3. The brake driving device according to claim 2, further comprising:
a detection unit configured to detect a potential of a power line connecting between the switch and the mechanical brake device when the switch is caused to perform the OFF motion for a fixed period of time while the brake by the mechanical brake device is released by causing the switch to perform the ON motion by control of the switch control unit; and
a diagnostic unit configured to make a diagnosis of presence or absence of a fault in the switch, based on a detection result of a potential by the detection unit.

4. The brake driving device according to claim 1, wherein
the energy storage circuit includes a capacitor connected in parallel with a brake coil of the mechanical brake device.

5. The brake driving device according to claim 1, wherein
the energy storage circuit includes an inductor connected in series with the brake coil of the mechanical brake device.

6. The brake driving device according to claim 1, wherein
the mechanical brake device applies a brake to a motor by pressing, by an elastic force of a spring, an armature against a friction plate to which a shaft of the motor is coupled, and releases the brake to the motor by separating the armature from the friction plate by an electromagnetic force generated by a current flowing through the brake coil.
